(19) United States
(12) Patent Application Publication
(10) Pub. No.: US 2021/0320690 A1
(43) Pub. Date: Oct. 14, 2021

(54) APPLIANCE CONTROL SYSTEM USING POWER LINE COMMUNICATIONS

(71) Applicant: Peter Brewster, Forked River, NJ (US)

(72) Inventor: Peter Brewster, Forked River, NJ (US)

(21) Appl. No.: 16/848,077

(22) Filed: Apr. 14, 2020

(51) Int. Cl. H04B 3/54; H01R 25/00; H02J 3/00; H02J 13/00

(52) U.S. Cl. CPC H04B 3/54; H02J 13/00007; H02J 3/00; H01R 25/006

(57) ABSTRACT

A system for controlling multiple electric appliances connected to an AC power line comprises multiple appliance controllers, each of which is connected to a PLC module. Each appliance controller is electrically connected between one of the electric appliances and the AC power line and is operable to control and provide power to the connected appliance. Each appliance controller receives, through the AC power line, appliance control signals containing an appliance address code, which is uniquely assigned to the appliance controller. In response to the appliance control signals, the appliance controller changes the status of the appliance to which it is connected. The PLC modules are contained in modular switch boxes. Each PLC module is programmable to transmit appliance control signals to one of the appliance controllers using the assigned appliance address code. The PLC module is part of a modular switch box, which is replaceably insertable into one of multiple receptacle boxes connected to the AC power line. Electrical power is transferred to the switch box through the receptacle box by conjugate electrical contacts on the exterior of the switch box and on the interior of the receptacle box. The receptacle boxes themselves are mechanically and electrically interconnected through conjugate electrical and mechanical connectors on the exterior of the receptacle boxes. This feature enables the receptacle boxes to be serially ganged, so that receptacle boxes can be added to the system without re-wiring.

### FIELD OF INVENTION

The present invention relates to the general field of remote controls for electrical appliances, and more particularly to such controls which utilize power line communications.

### BACKGROUND OF THE INVENTION

There are many advantages to systems by which switches are connected to the appliances they control without dedicated wiring between the switch and the appliance. Such systems reduce both the initial installation costs as well as the costs of changing or adding additional switches and/or appliances. Some of these systems use wireless communications technology, such as Wi-Fi or Bluetooth, to connect switches to appliances. Others send switching signals over the AC line that powers the appliance, using Power Line Communications (PLC) or Broadband Over Power Lines (BPL) technology. These technologies allow any switch to be programmed to control any appliance connected to the same power supply.

While the foregoing technologies simplify the task of installing and changing switches, they do not eliminate the complex wiring which often requires a trained electrician and poses safety hazards for the do-it-yourself homeowner. The present invention aims to address this shortcoming by providing modular receptacle boxes into which conjugate modular switches are inserted, using mating electrical contacts without the need for wiring beyond the installation of the initial receptacle box.

### SUMMARY OF THE INVENTION

The present invention is a system for controlling multiple electric appliances connected to an AC power line. The system comprises multiple appliance controllers, each of which is connected to a PLC module. Each appliance controller is electrically connected between one of the electric appliances and the AC power line and is operable to control and provide power to the connected appliance. Each appliance controller receives, through the AC power line, appliance control signals containing an appliance address code, which is uniquely assigned to the appliance controller. In response to the appliance control signals, the appliance controller changes the status of the appliance to which it is connected. For example, if the appliance controller is connected to a lighting fixture, the appliance control signals would contain coding to change the fixture's status in terms of on-off or bright-dim.

The PLC modules are contained in modular switch boxes. Each PLC module is programmable to transmit appliance control signals to one of the appliance controllers using the assigned appliance address code. The PLC programming enables each switch box to be re-assigned to any one of the appliance controllers by changing the appliance address code transmitted by the PLC module. This feature advantageously allows each switch box to be paired with any of the appliances without re-wiring.

The PLC module is part of a modular switch box, which is replaceably insertable into one of multiple receptacle boxes connected to the AC power line. Electrical power is transferred to the switch box through the receptacle box by conjugate electrical contacts on the exterior of the switch box and on the interior of the receptacle box. These conjugate electrical contacts correspondingly engage one another upon insertion of the switch box into the receptacle box. For example, a receptacle box would have three interior female contacts for hot, neutral and ground wires, which would mate with three corresponding exterior male contacts on the switch box, thereby energizing the switch box.

The receptacle boxes themselves are mechanically and electrically interconnected through conjugate electrical and mechanical connectors on the exterior of the receptacle boxes. This feature enables the receptacle boxes to be serially ganged, so that receptacle boxes can be added to the system without re-wiring.

One of the technical challenges associated with PLC control systems is avoiding the collision of control signals from different PLC modules in the AC power line. These signals are timed to coincide with the zero-crossings of the AC voltage, and if two different signals arrive at the same zero-crossing, interference results. To deal with this problem, the present invention incorporates in its PCS module a signal delay means, which detects collisions between two or more appliance control signals and delays one or more of the appliance control signals in order to avoid or eliminate the detected signal collisions. The signal delay means of the present invention operates in accordance with either one of the systems described in U.S. Pat. Nos. 6,229,433 or 6,750,781, which are incorporated herein by reference.

The foregoing summarizes the general design features of the present invention. In the following sections, specific embodiments of the present invention will be described in some detail. These specific embodiments are intended to demonstrate the feasibility of implementing the present invention in accordance with the general design features discussed above. Therefore, the detailed descriptions of these embodiments are offered for illustrative and exemplary purposes only, and they are not intended to limit the scope either of the foregoing summary description or of the claims which follow.

### BRIEF DESCRIPTION OF THE DRAWINGS

FIG. 1 is a perspective view of a modular switch box according to one embodiment of the present invention;

FIG. 2 is an exploded perspective view of the modular switch box of FIG. 1 inserted into a conjugate modular receptacle box according to one embodiment of the present invention;

FIG. 3A is a left side profile view of the modular switch box of FIG. 2;

FIG. 3B is a front view of the modular switch box of FIG. 2;

FIG. 4A is left side profile view of the modular receptacle box of FIG. 2;

FIG. 4B is a front view of the modular receptacle box of FIG. 2;

FIG. 5A is a perspective view of the modular receptacle box of FIG. 2, showing the exterior mechanical and electrical connectors;

FIG. 5B is a perspective view of the modular receptacle box of FIG. 2, with the location of the exterior electrical connectors indicated by the dashed oval labelled 5D;

FIG. 5C is a left side profile view of the modular receptacle box of FIG. 2, showing the exterior mechanical and electrical connectors;

FIG. 5D is a detail profile view of the exterior electrical connectors shown in FIG. 5B;

FIG. 6 is a schematic diagram of the electrical current flow through a ganged series of three modular receptacle boxes of the type shown in FIG. 2; and

FIG. 7 is a block diagram of the interior circuitry of the modular switch box according to one embodiment of the present invention.

### DETAILED DESCRIPTION OF THE PREFERRED EMBODIMENT

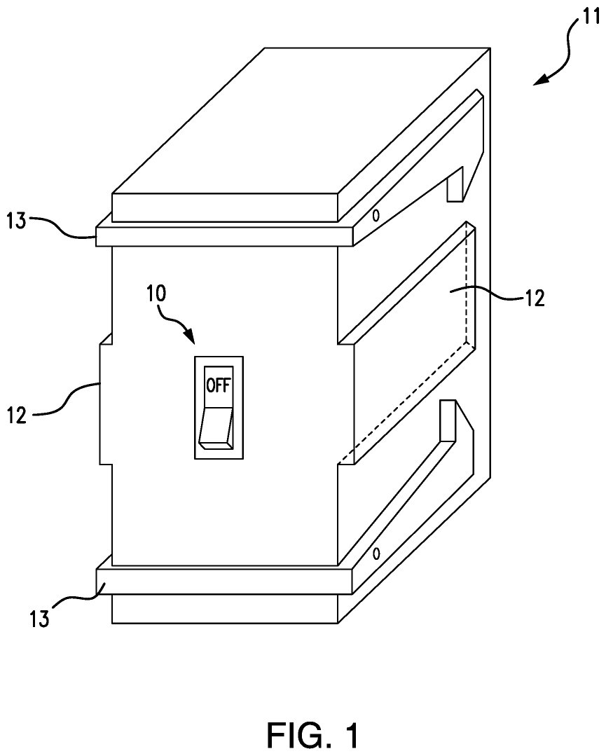

Referring to FIG. 1, an exemplary modular switch box 11 exterior comprises a switch input 10, two switch flanges 12 and two spring-loaded switch pawls 13. The switch input 10 can be a mechanical on-off switch, as shown, or a remote-control switch receptor (not shown).

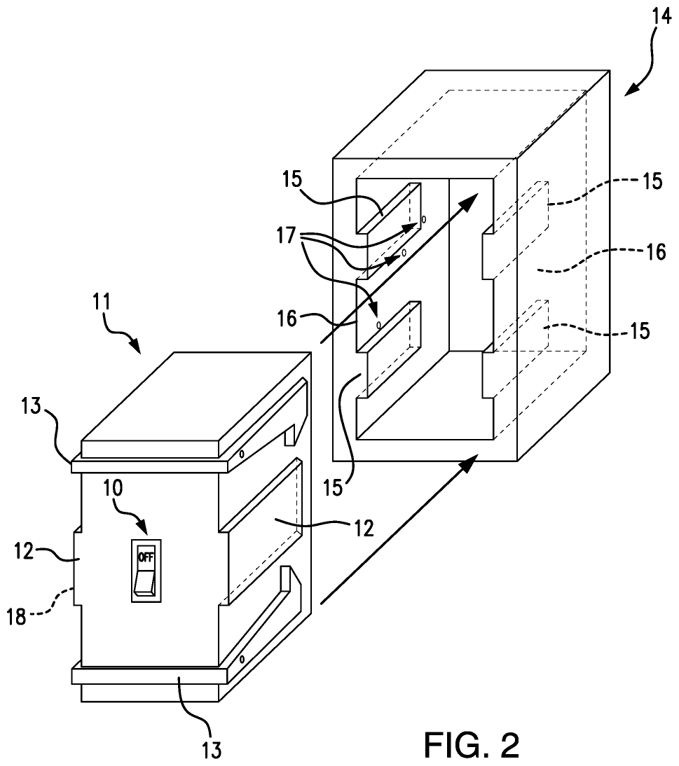

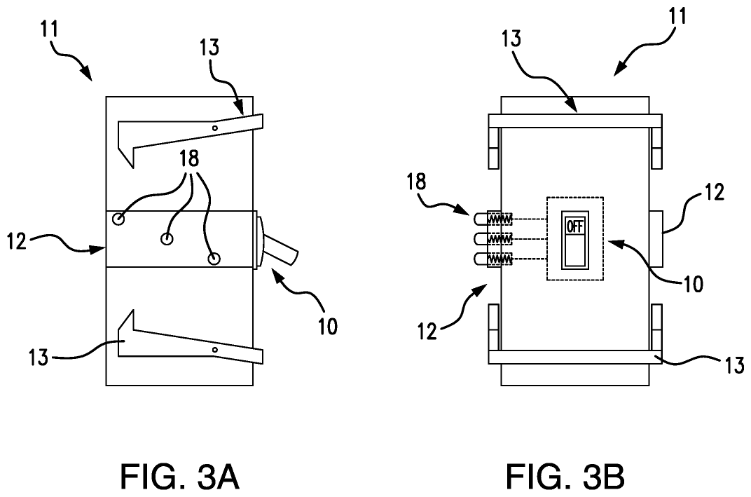

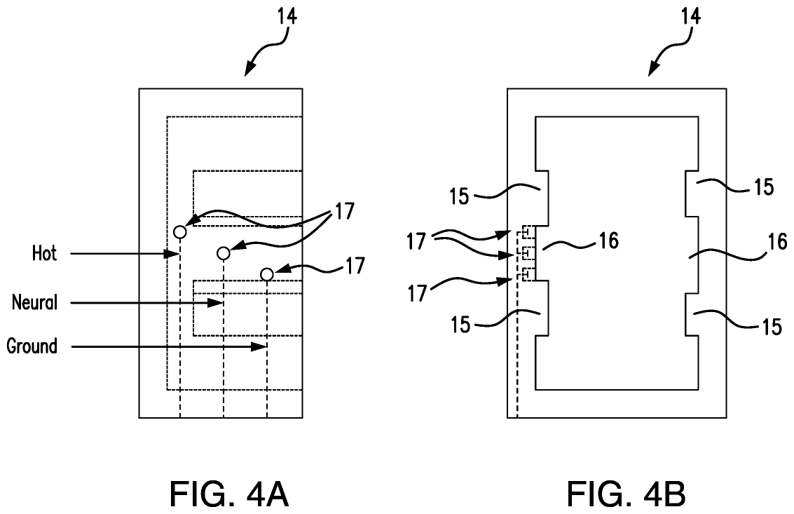

FIG. 2 illustrates the conjugate mating of the modular switch box 11 with an exemplary modular receptacle box 14. The mechanical aspect of the mating is accomplished by sliding the switch flanges 12 into the two conjugate receptacle channels 16 and depressing the two switch pawls 13 to engage the two receptacle flanges 15. The electrical aspect of the mating comprises engagement between three recessed female electrical contacts 17 inside the receptacle box 14, as depicted in FIGS. 4A and 4B, and three spring-loaded male electrical contacts 18 on the left exterior of the switch box 11, as depicted in FIGS. 3A and 3B. The three conjugate electrical contacts 17 18 correspond to the hot, neutral and ground wires of the AC power line 30.

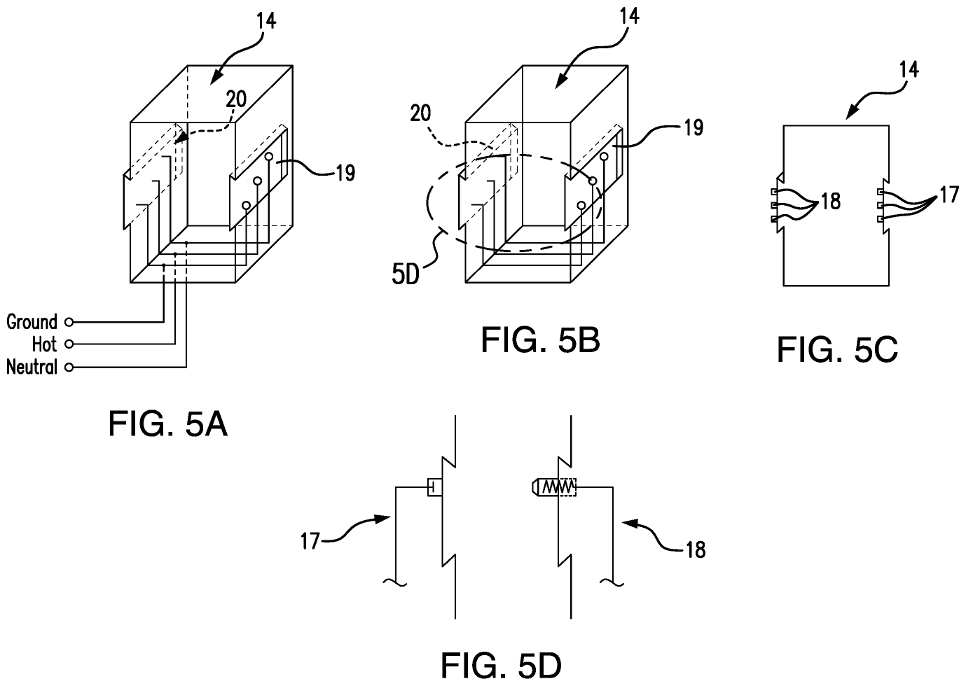

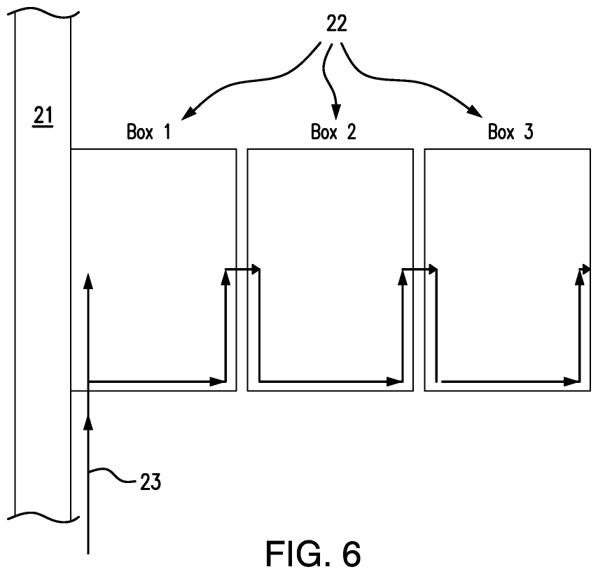

As illustrated in FIGS. 5A-5D, the modular receptacle boxes 14 are serially ganged together by conjugate exterior receptacle grooves 19 and receptacle ridges 20. In the depicted example, the grooves 19 are on the exterior right side of the receptacle boxes 14 and the ridges 20 on the exterior left side, but it should be understood that these positions be reversed without altering the operation of the system. As shown, the receptacle grooves 19 contain the three recessed female electrical contacts 17, while the receptacle ridges 20 contain the conjugate spring-loaded male electrical contacts 18. FIG. 6 illustrates three exemplary ganged receptacle boxes 22 attached to a wall stud 21, with the AC current flow 23 through the ganged receptacle boxes 22.

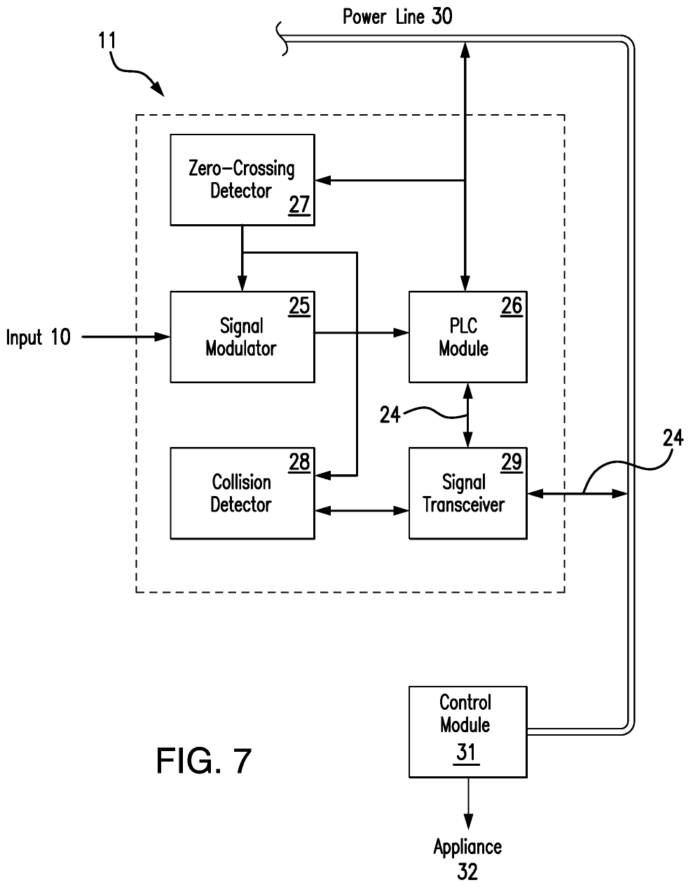

FIG. 7 depicts exemplary circuitry within the modular switch box 11. As stated previously, the switch input 10 can be direct manual or remote, which is converted to digital format by the signal modulator 25 and transmitted to the PLC module 26. The PLC module 26 generates an appliance control signal 24 which is transmitted by the signal transceiver 29 through the AC power line 30 to the appliance controller 31, which controls the status of the appliance 32. The zero-crossing detector 27 monitors the timing of the appliance control signal 24 in the power line 30 and activates the collision detector 28 when multiple appliance control signals 24 coincide, causing one or more of the control signals 24 to be delayed in order to avoid signal collisions.

Although the preferred embodiment of the present invention has been disclosed for illustrative purposes, those skilled in the art will appreciate that many additions, modifications and substitutions are possible, without departing from the scope and spirit of the present invention as defined by the accompanying claims.

1. A system for controlling operations of multiple electric appliances, each of which is electrically connected to an AC power line, the system comprising:
multiple appliance controllers, wherein each of the multiple appliance controllers are electrically connected between one of the multiple electric appliances and the AC power line, and wherein each appliance controller of the multiple appliance controllers is operable to control and provide power to an electric appliance of the multiple electric appliances to which an appliance controller of the multiple appliance controllers is electrically connected, and wherein each appliance controller of the multiple appliance controllers receives through the AC power line, appliance control signals containing an appliance address code which is uniquely assigned to the appliance controller of the multiple appliance controllers, and wherein, in response to the appliance control signals, the appliance controller of the multiple appliance controllers changes the status of the electric appliance of the multiple electric appliances to which the appliance controller of the multiple appliance controllers is electrically connected;
multiple power line communications (PLC) modules, wherein each PLC module of the multiple PLC modules has PLC programming which enables the PLC module of the multiple PLC modules to transmit the appliance control signal to one of the multiple appliance controllers, using the appliance address code assigned to the appliance controller, and wherein the PLC programming enables the appliance address code to be changed, so that each of the multiple PLC modules can be programmed to transmit the appliance control signal to any one of the appliance controllers, thereby enabling the PLC module of the multiple PLC modules to be paired with different appliances without re-wiring.

2. The system according to claim 1, wherein the PLC module of the multiple PLC modules is part of a modular switch box, and wherein the modular switch box is replaceably insertable into one of multiple receptacle boxes which are electrically connected to the AC power line, and wherein power is transferred to the modular switch box through a receptacle box of the multiple receptacle boxes by conjugate electrical contacts, which are exterior on the modular switch box and interior on the receptacle box of the multiple receptacle boxes, so that the conjugate electrical contacts correspondingly engage one another upon insertion of the modular switch box into the receptacle box.

3. The system according to claim 2, wherein the multiple receptacle boxes are electrically and mechanically interconnectable through conjugate electrical and mechanical connectors which are exterior on the multiple receptacle boxes, thereby enabling addition of receptacle boxes to the system without re-wiring.

4. The system according to claim 2, wherein the modular switch box, in addition to the PLC module, comprises a signal delay means, and wherein the signal delay means is electrically connected to the AC power line and is operable to detect collisions between two or more of the appliance control signals and to delay one or more of the appliance control signals in order to avoid or eliminate the collisions so detected.

5. The system according to claim 3, wherein the modular switch box, in addition to the PLC module, comprises a signal delay means, and wherein the signal delay means is electrically connected to the AC power line and is operable to detect collisions between two or more of the appliance control signals and to delay one or more of the appliance control signals in order to avoid or eliminate the collisions so detected.
